(19) United States
(12) Patent Application Publication
(10) Pub. No.: US 2021/0191309 A1
(43) Pub. Date: Jun. 24, 2021

(54) IMAGE FORMING APPARATUS

(71) Applicant: KYOCERA Document Solutions Inc., Osaka (JP)

(72) Inventors: Koji TANIO, Osaka (JP); Takashi KUSUKAWA, Osaka (JP)

(73) Assignee: KYOCERA Document Solutions Inc., Osaka (JP)

(21) Appl. No.: 17/125,570

(22) Filed: Dec. 17, 2020

(30) Foreign Application Priority Data
Dec. 23, 2019 (JP) 2019-231188

(51) Int. Cl. G03G 21/16

(52) U.S. Cl. CPC G03G 21/1647; G03G 21/1676

(57) ABSTRACT

An image forming apparatus includes an image carrying member, a developing device, a toner holder, a toner holder mount portion, and a locking member. The toner holder is dismountably mounted in the toner holder mount portion and stores toner for the developing device. The toner holder mount portion has a pair of side support rails supporting a side face of the toner holder. The locking member is adjacent to an end part, in the toner holder mounting direction, of at least one side support rail, and is swingable between a first position restraining mounting and dismounting of the toner holder and a second position allowing mounting and dismounting of the toner holder. The locking member, in the second position, is on the extension line of the side support rails and, together with the side support rails, guides the toner holder to and from the toner holder mount portion.

### INCORPORATION BY REFERENCE

This application is based on and claims the benefit of Japanese Patent Application No. 2019-231188 filed on Dec. 23, 2019, the contents of which are hereby incorporated by reference.

### BACKGROUND

The present disclosure relates to image forming apparatuses that employ an electrophotographic process, such as copiers, printers, and facsimile machines. More particularly, the present disclosure relates to image forming apparatuses that incorporate a toner container which is dismountably mounted in the body of the image forming apparatus.

In known image forming apparatuses relying on electrophotography, it is common to sense toner concentration (or the amount of toner) in a developing device with a toner sensor to supply, as toner concentration (the amount of toner) diminishes, additional toner from a toner holder such as a toner container to the developing device.

In such image forming apparatuses, a toner holder is usually replaced with a new one when it becomes empty. Inconveniently, if a toner holder is replaceable with some toner still remaining in it, it may be disposed of despite being still usable with the toner remaining in it.

To cope with that, in a known image forming apparatus, whether the amount of remaining toner is sufficient is monitored based on the result of sensing of toner condition by a process cartridge condition monitoring controller so that, so long as the amount of remaining toner is found to be sufficient, the process cartridge is judged not to have reached the time for replacement yet, in which case a solenoid is turned off by a stopper controller so that the stopper function is enabled.

Another known image forming apparatus includes a locking means for locking a cover of a toner holder mounted; a sensing means for sensing depletion of toner in the toner holder mounted; and a displaying means for displaying on a display a screen for accepting, when the sensing means senses depletion of toner, input for performing replacement of the toner holder that has been sensed to be devoid of toner. In this image forming apparatus, in response to input being accepted via a screen displayed by the displaying means, the lock exerted by the locking means (a toner bottle cover) is released, and this permits replacement of the toner holder that has been sensed to be devoid of toner.

### SUMMARY

According to one aspect of the present disclosure, an image forming apparatus includes an image carrying member, a developing device, a toner holder, a toner holder mount portion, and a locking member. On the image carrying member, an electrostatic latent image is formed. The developing device forms a toner image by attaching toner to the electrostatic latent image formed on the image carrying member. The toner holder that is dismountably mounted and stores toner to be supplied to the developing device. In the toner holder mount portion, the toner holder is mounted. The locking member restrains mounting and dismounting of the toner holder in and from the toner holder mount portion. The toner holder mount portion has a pair of side support rails that supports a side face of the toner holder. The locking member is arranged adjacent to an upstream end part, in the mounting direction of the toner holder, of at least one of the side support rails, and is swingable between a first position where the locking member is perpendicular to the extension direction of the side support rails and restrains mounting and dismounting of the toner holder and a second position where the locking member is parallel to the extension direction of the side support rails and permits mounting and dismounting of the toner holder. The locking member, when in the second position, is arranged on the extension line of the side support rails, and guides, together with the side support rails, the toner holder to and from the toner holder mount portion.

This and other objects of the present disclosure, and the specific benefits obtained according to the present disclosure, will become apparent from the description of embodiments which follows.

### BRIEF DESCRIPTION OF THE DRAWINGS

FIG. 1 is a schematic sectional view showing an overall construction of an image forming apparatus according to one embodiment of the present disclosure;

FIG. 2 is a side sectional view of a developing device incorporated in the image forming apparatus according to the embodiment;

FIG. 3 is a side sectional view of a toner container incorporated in the image forming apparatus according to the embodiment;

FIG. 4 is a block diagram showing one example of control paths in the image forming apparatus according to the embodiment;

FIG. 5 is a perspective view of the image forming apparatus with a top cover open, as seen from above;

FIG. 6 is an enlarged part view around locking members for the toner containers in FIG. 5;

FIG. 7 is a perspective view showing a structure of a toner container mount portion at its rear frame side, showing a locked state achieved by the locking members:

FIG. 8 is a perspective view showing the structure of the toner container mount portion at its rear frame side, showing an unlocked state achieved by the locking members;

FIG. 9 is a diagram showing a lock release driving portion of a locking member, as seen from the rear side in FIG. 7;

FIG. 10 is a side view schematically showing first to fourth mount portions of the container mount portion with toner containers mounted in them;

FIG. 11 is a side view schematically showing how the toner containers are dismounted from the state in FIG. 10;

FIG. 12 is a flow chart showing a procedure for replacing toner containers in the image forming apparatus according to the embodiment; and

FIG. 13 is a perspective view showing the structure of the toner container mount portion at its rear frame side, showing how a toner container is replaced.

### DETAILED DESCRIPTION

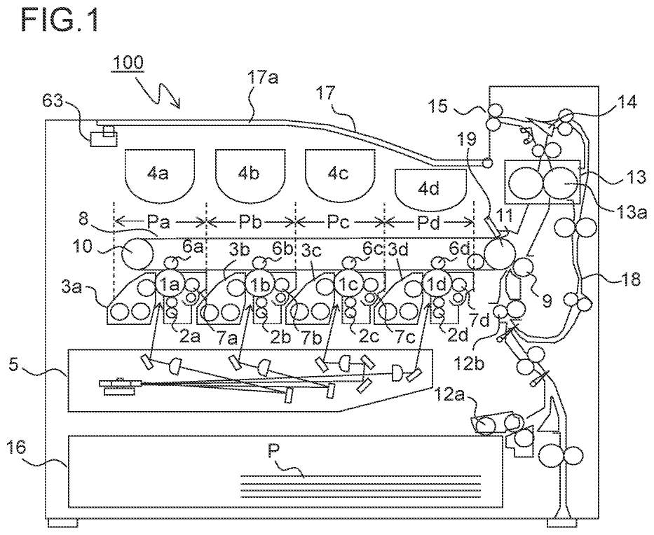

An embodiment of the present disclosure will be described below with reference to the accompanying drawings. FIG. 1 is a sectional view showing an internal construction of an image forming apparatus 100 according to one embodiment of the present disclosure. In the body of the image forming apparatus 100 (here, a color printer), four image forming portions Pa, Pb, Pc, and Pd are arranged in this order from upstream (in FIG. 1, the left side) in the conveying direction. These image forming portions Pa to Pd are provided to correspond to four different colors (cyan, magenta, yellow, and black), and respectively form a cyan, a magenta, a yellow, and a black image sequentially through the processes of charging, exposure, developing, and transfer.

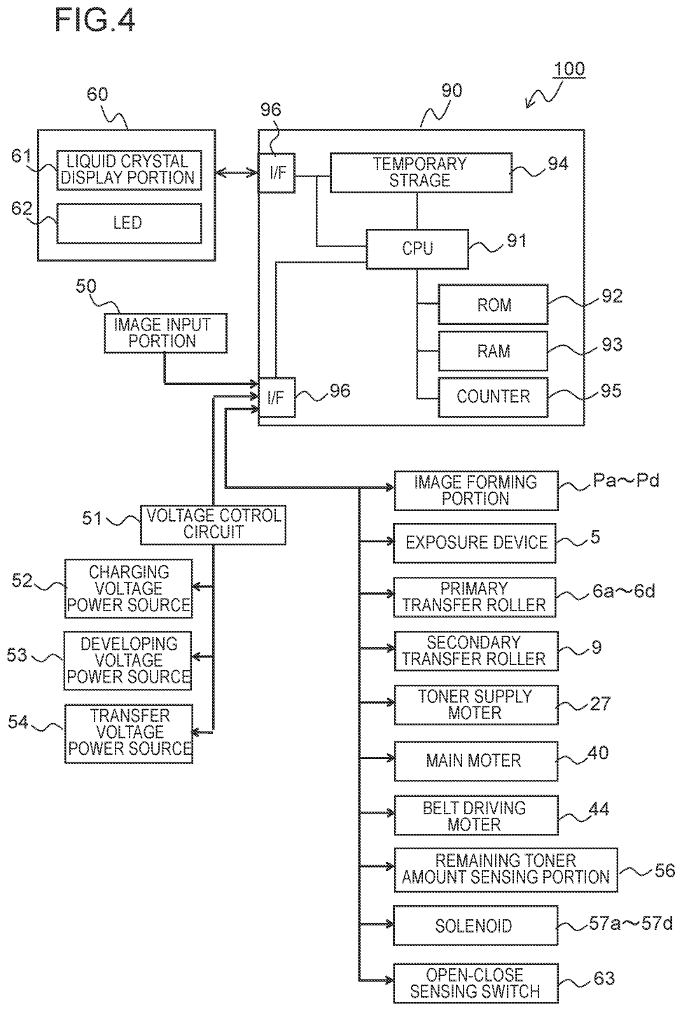

In the image forming portions Pa to Pd, photosensitive drums (image carrying members) 1a, 1b, 1c, and 1d that carry visible images (toner images) of different colors are arranged. Also an intermediate transfer belt 8 that is driven by a belt driving motor 44 (see FIG. 4) to rotate counter-clockwise in FIG. 1 is provided adjacent to the image forming portions Pa to Pd. The toner images formed on the photosensitive drums 1a to 1d are, by being primarily transferred sequentially to the intermediate transfer belt 8, which moves while in contact with the photosensitive drums 1a to 1d, overlaid on each other. Thereafter, the toner images primarily transferred to the intermediate transfer belt 8 are secondarily transferred by a secondary transfer roller 9 to a transfer sheet P as one example of a recording medium. The transfer sheet P having the toner images secondarily transferred to it then has the toner images fixed to it in a fixing portion 13, and is then discharged out of the body of the image forming apparatus 100. While the photosensitive drums 1a to 1d are rotated clockwise in FIG. 1, an image forming process is performed with respect to the photosensitive drums 1a to 1d.

Transfer sheets P to which toner images will eventually be secondarily transferred are stored inside a sheet cassette 16 arranged in a lower part of the body of the image forming apparatus 100. A transfer sheet P is conveyed via a sheet feed roller 12a and a pair of registration rollers 12b to the nip between the secondary transfer roller 9 and a driving roller 11 for the intermediate transfer belt 8. Used as the intermediate transfer belt 8 is a sheet of a dielectric resin, typically a belt with no seam (a seamless belt). Downstream of the secondary transfer roller 9, a blade-form belt cleaner 19 for removing toner and the like left on the surface of the intermediate transfer belt 8 is provided.

Next, the image forming portions Pa to Pd will be described. Around and under the photosensitive drums 1a to 1d, which are arranged rotatably, there are provided charging device 2a, 2b, 2c, and 2d which electrostatically charge the photosensitive drums 1a to 1d, an exposure device 5 which exposes the photosensitive drums 1a to 1d to light conveying image information, developing device 3a, 3b, 3c, and 3d which form toner images on the photosensitive drums 1a to 1d, and cleaning devices 7a, 7b, 7c, and 7d which remove developer (toner) and the like left on the photosensitive drums 1a to 1d.

When image data is fed in from a host device such as a personal computer, first, the charging devices 2a to 2d electrostatically charge the surfaces of the photosensitive drums 1a to 1d uniformly. Next, the exposure device 5 radiates light based on the image data so that electrostatic latent images based on the image data are formed on the photosensitive drums 1a to 1d. The developing devices 3a to 3d are loaded with predetermined amounts of two-component developer containing cyan, magenta, yellow, and black toner respectively. When, as toner images are formed as will be described later, the proportion of toner in the two-component developer in the developing devices 3a to 3d falls below a prescribed value, fresh toner is additionally fed from toner containers 4a to 4d to the developing devices 3a to 3d. The toner in the developer is supplied by the developing devices 3a to 3d onto, so as to electrostatically attach to, the photosensitive drums 1a to 1d. In this way, toner images that correspond to the electrostatic latent images formed by exposure to light from the exposure device 5 are formed on the photosensitive drums 1a to 1d.

Primary transfer rollers 6a to 6d produce an electric field with a predetermined transfer voltage between the primary transfer rollers 6a to 6d and the photosensitive drums 1a to 1d so that the cyan, magenta, yellow, and black toner images on the photosensitive drums 1a to 1d are primarily transferred to the intermediate transfer belt 8. These images of four colors are formed in a prescribed predetermined positional relationship with each other so as to form a predetermined full-color image. Thereafter, in preparation for the subsequent formation of new electrostatic latent images, the toner and the like that are left on the surfaces of the photosensitive drums 1a to 1d after primary transfer are removed by the cleaning devices 7a to 7d.

The intermediate transfer belt 8 is stretched around a driven roller 10, located upstream, and a driving roller 11, located downstream. When, as the driving roller 11 rotates by being driven by a belt driving motor 44 (see FIG. 4), the intermediate transfer belt 8 starts to move around counter-clockwise, a transfer sheet P is conveyed, with predetermined timing, from the pair of registration rollers 12b to the nip (secondary transfer nip) between the driving roller 11 and the secondary transfer roller 9, the latter being provided adjacent to the former, with the result that the full-color image on the intermediate transfer belt 8 is secondarily transferred to the transfer sheet P. The transfer sheet P having the toner images secondarily transferred to it is conveyed to the fixing portion 13.

The transfer sheet P conveyed to the fixing portion 13 is heated and pressed by a pair of fixing rollers 13a so that the toner images are fixed to the surface of the transfer sheet P, thereby forming the predetermined full-color image. The transfer sheet P having the full-color image formed on it has its conveying direction switched by a branch portion 14 branching into a plurality of directions so as to be discharged as it is (or after being fed into a duplex passage 18 and subjected to duplex printing) onto a discharge tray 17 by a pair of discharge rollers 15.

On the top face of the image forming apparatus 100, a top cover 17a, which forms part of the discharge tray 17, is provided. With the top cover 17a open, the toner containers 4a to 4d are mounted in the body of the image forming apparatus 100, or are taken out of the body of the image forming apparatus 100. Near the swinging end (the left end in FIG. 1) of the top cover 17a, there is arranged an open-close sensing switch 63 for sensing whether the top cover 17a is open or closed.

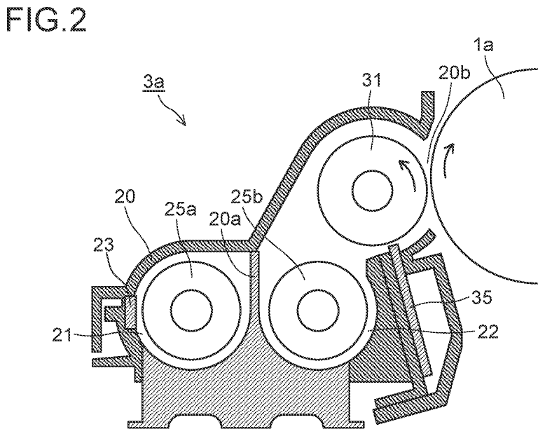

FIG. 2 is a side sectional view of the developing device 3a incorporated in the image forming apparatus 100. While the following description deals with, as an example, the developing device 3a arranged in the image forming portion Pa in FIG. 1, the developing devices 3b to 3d arranged in the image forming portions Pb to Pd have basically the same structure, and therefore no overlapping description will be repeated.

As shown in FIG. 2, the developing device 3a has a developer holder 20 in which two-component developer (hereinafter referred to simply as developer) containing magnetic carrier and toner is stored. The developer holder 20 is divided into a stirring-conveying chamber 21 and a feeding-conveying chamber 22 by a partition wall 20a. In the stirring-conveying chamber 21 and the feeding-conveying chamber 22 respectively, there are rotatably arranged a stirring-conveying screw 25a and a feeding-conveying screw 25b for mixing the toner fed from the toner container 4a (see FIG. 1) with magnetic carrier and stirring and electrostatically charging the toner.

The developer is conveyed, while being stirred, by the stirring-conveying screw 25a and the feeding-conveying screw 25b in the axial direction (in the direction perpendicular to the plane of FIG. 2), and circulates between the stirring-conveying chamber 21 and the feeding-conveying chamber 22 through unillustrated developer passages formed in opposite end parts of the partition wall 20a. That is, the stirring-conveying chamber 21, the feeding-conveying chamber 22, and the developer passages form a circulation passage for developer inside the developer holder 20.

The developer holder 20 extends diagonally up rightward in FIG. 2, and inside the developer holder 20, a developing roller 31 is arranged diagonally to the upper right of the feeding-conveying screw 25b. Part of the outer circumferential face of the developing roller 31 is exposed through an opening 20b in the developer holder 20 to face the photosensitive drum Ia. The developing roller 31 rotates counter-clockwise in FIG. 2.

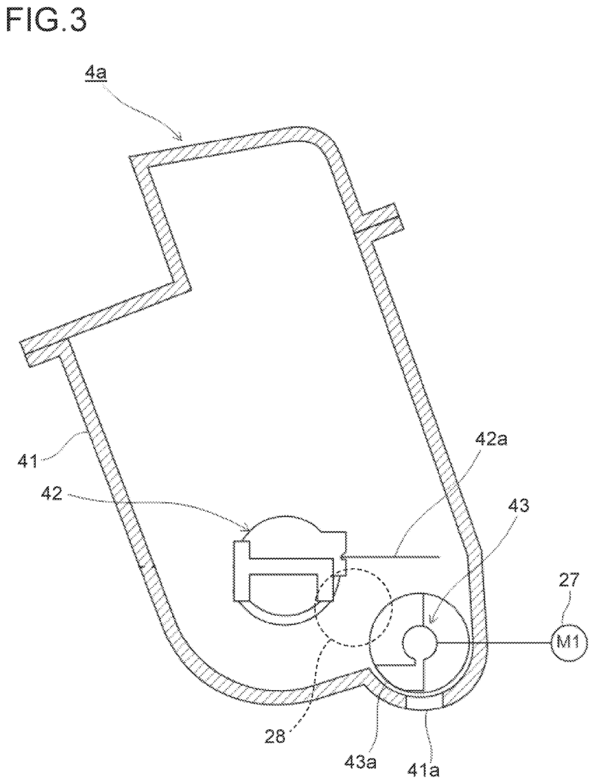

In the conveying chamber 21, a toner concentration sensor 23 is arranged opposite the stirring-conveying screw 25a. Used as the toner concentration sensor 31 is a magnetic permeability sensor that senses the magnetic permeability of the two-component developer inside the developer holder 20. Here, toner concentration refers to the ratio (TIC) of toner to magnetic carrier in developer. In the embodiment, the magnetic permeability of developer is sensed by the toner concentration sensor 23, and a voltage value that reflects the result of the sensing is fed to a control portion 90 (see FIG. 4), which will be described later. Then in the control portion 90, the toner concentration is determined based on the output value of the toner concentration sensor 23. According to the determined toner concentration, the control portion 90 feeds a control signal to a toner feed motor 27 (see FIGS. 3 and 4) to supply a predetermined amount of toner into the developer holder 20.

The output value of the toner concentration sensor 23 varies with the toner concentration. Specifically, the higher the toner concentration, the higher the ratio of toner to magnetic carrier, resulting in an increased proportion of toner, which is impermeable to magnetism, and hence a lower output value; the lower the toner concentration, the lower the ratio of toner to magnetic carrier, resulting in an increased proportion of magnetic carrier, which is permeable to magnetism, and hence a higher output value.

The developing roller 31 is composed of a developing sleeve, which is cylindrical and which rotates counter-clockwise in FIG. 2, and a magnet (not illustrated) with a plurality of magnetic poles, which is fixed inside the developing sleeve. A developing voltage that has an alternating-current voltage Vslv(AC) superposed on a direct-current voltage Vslv(DC) by a developing voltage power source 53 (see FIG. 4) is applied to the developing roller 31.

In the developer holder 20, a restricting blade 35 is fitted along the lengthwise direction (the direction perpendicular to the plane of FIG. 2) of the developing roller 31. Between a tip end part of the restricting blade 35 and the surface of the developing roller 31, there is formed a small interval (gap).

FIG. 3 is a side sectional view of a toner container 4a incorporated in the image forming apparatus 100. While the following description deals with, as an example, the toner container 4a that supplies toner to the developing device 3a, the toner containers 4b to 4d that supply toner to the developing devices 3b to 3d have basically the same structure, and therefore no overlapping description will be repeated. The toner container 4a includes a container casing 41 in which fresh toner is stored, a stirring paddle 42, and a conveying screw 43.

In one end part of a bottom part of the container casing 41 in its longitudinal direction (the direction perpendicular to the plane of FIG. 3), there is formed a feed port 41a which is connected to a toner supply port (not illustrated) of the developer holder 20. The stirring paddle 42 has a stirring blade 42a that protrudes from a rotary shaft to one side in a radial direction and that extends in the longitudinal direction of the container casing 41. As the stirring blade 42a rotates, the toner inside the container casing 41 is stirred, and the stirred toner is conveyed toward the conveying screw 43.

The conveying screw 43 has, around a rotary shaft, a helical blade 43a that is formed in the shape of a helix with a predetermined phase (pitch) in the longitudinal direction, and is arranged opposite the feed port 41a in a bottom part inside the container casing 41. As the conveying screw 43 rotates, the toner stirred by the stirring paddle 42 is conveyed toward the feed port 41a while the phase of the helical blade 43a advances, and is supplied via the feed port 41a into the developer holder 20. The stirring blade 42a of the stirring paddle 42 protrudes in a radial direction to reach the outer edge of the conveying screw 43, and can be brought into contact with the helical blade 43a.

To the conveying screw 43, a toner supply motor 27 is connected. The toner supply motor 27 is a DC motor that makes the conveying screw 43 rotate, and is driven to rotate, for example, as a result of a pulse voltage applied to a bridge circuit being turned on and off repeatedly. Outside the container casing 41, an idle gear 28 that is coupled to the conveying screw 43 and to the stirring paddle 42 is arranged. The rotation driving force fed to the conveying screw 43 by the toner supply motor 27 is transmitted via the idle gear 28 to the stirring paddle 42, which thus rotates.

With a sufficient amount of toner stored in the container casing 41, the stirring paddle 42 stirs toner and supplies it to the conveying screw 43. As the toner supply motor 27 rotates at a constant speed, the conveying screw 43 supplies a predetermined amount of toner commensurate with the rotation speed via the feed port 41a into the developer holder 20. Thus the toner concentration inside the developer holder 20 is kept constant. If, despite toner being supplied, the toner concentration in the developer inside the developer holder 20 as detected by the toner concentration sensor 23 (see FIG. 2) does not rise, the control portion 90 judges that the toner container 4a is empty of toner. The control portion 90 indicates on a liquid crystal display portion 61 (see FIG. 4) that no toner remains in the toner container 4a (hereinafter referred to “toner depletion”), and prompts the user to replace the toner container 4a.

If toner depletion is indicated suddenly, in a case where preparation of a replacement toner container 4a takes time, the user may be left unable to use the image forming apparatus 100 for a while. To avoid that, before toner depletion is indicated, a state of near-depletion of toner (hereinafter referred to as “near-depletion”) is recognized and is indicated on the liquid crystal display portion 61 so that, when near-depletion is indicated, the user can make time for the preparation of a replacement toner container 4a.

The speed of supply of toner from the toner container 4a is constant so long as a sufficient amount of toner remains in the toner container 4a However, as the amount of toner in the toner container 4a diminishes, the speed of supply decreases. In view of this, when the amount of toner supplied from the toner container 4a per unit time has diminished to a predetermined amount, near-depletion is indicated, and when the amount of toner supplied diminishes further, toner depletion is indicated. Near-depletion can be detected, like toner depletion, based on the toner concentration in the developer inside the developer holder 20 as sensed by the toner concentration sensor 23, or can be predicted based on the toner coverage ratio calculated from the image signal of the images printed.

FIG. 4 is a block diagram showing one example of control paths used in an image forming apparatus 100 according to the present disclosure. It should be noted that, as various kinds of control are performed on different parts of the image forming apparatus 100 during its use, the image forming apparatus 100 as a whole has complicate control paths. The following description however focuses on those control paths which are needed to implement the present disclosure.

The control portion 90 at least includes a CPU (central processing unit) 91 as a central arithmetic processor, a ROM (read-only memory) 92 which is a storage for reading-out only, a RAM (random-access memory) 93 which is a storage for both reading-out and writing-to, a temporary storage 94 for temporarily storing image data and the like, a counter 95, and a plurality of (here, two) I/Fs (interfaces) 96 for transmitting control signals to different devices within the image forming apparatus 100 and for receiving input signals from an operation portion 60.

The ROM 92 stores control programs for the image forming apparatus 100, values and the like necessary for control, data that remains unchanged during the use of the image forming apparatus 100, and the like. The RAM 93 stores necessary data generated in the course of controlling the image forming apparatus 100, data temporarily needed for controlling the image forming apparatus 100, and the like. The counter 95 counts the number of printed sheets on a cumulative basis.

The control portion 90 transmits control signals from the CPU 91 via the I/Fs 96 to different parts and devices in the image forming apparatus 100. From those different parts and devices, signals indicating their states and input signals are transmitted via the I/Fs 96 to the CPU 91. The different parts and devices controlled by the control portion 90 include, for example, the image forming portions Pa to Pd, the exposure device 5, the primary transfer rollers 6a to 6d, the secondary transfer roller 9, the toner supply motor 27, a main motor 40, the belt driving motor 44, an image input portion 50, a voltage control circuit 51, a remaining toner amount sensing portion 56, solenoids 57a to 57d, the operation portion 60, the open-close sensing switch 63, and the like.

The main motor 40 drives, to make rotate, the photosensitive drums 1a to 1d, the stirring-conveying screw 25a, the feeding-conveying screw 25b, the developing roller 31 in the developing devices 3a to 3d, and the like.

The image input portion 50 is a reception portion that receives image data transmitted from a personal computer or the like to the image forming apparatus 100. An image signal fed in via the image input portion 50 is converted into a digital signal and is then fed to the temporary storage 94.

The voltage control circuit 51 is connected to a charge voltage power source 52, a developing voltage power source 53, and a transfer voltage power source 54, and makes these power sources operate according to output signals from the control portion 90. In accordance with control signals from the voltage control circuit 51, the charge voltage power source 52 applies a predetermined voltage to charging rollers (not illustrated) in the charging devices 2a to 2d, the developing voltage power source 53 applies a predetermined voltage to developing rollers 31 in the developing devices 3a to 3d, and the transfer voltage power source 54 applies a predetermined voltage to the primary transfer rollers 6a to 6d and the secondary transfer roller 9.

The remaining toner amount sensing portion 56 includes the toner concentration sensor 23 (see FIG. 2) and the like, and senses whether the remaining toner amount in the toner containers 4a to 4d is above a predetermined threshold value. Specifically, if, after toner is suppled, the output value of the toner concentration sensor 23 does not fall, or reaches a predetermined threshold value set by the user, the toner containers 4a to 4d are judged to be close to empty, and near-depletion is indicated on the liquid crystal display portion 61. Specifically, a message indicating that the time for replacement of the toner containers 4a to 4d is close at hand (for example, a message like “Toner will run out soon”) is displayed.

When, as toner is consumed further, the output value of the toner concentration sensor 23 rises until it reaches the predetermined threshold value, the toner containers 4a to 4d are judged to be empty, and toner depletion is indicated on the liquid crystal display portion 61. Specifically, a message indicating that the time for replacement of the toner containers 4a to 4d has come (for example, a message like “Toner has run out; please replace the containers”) is displayed.

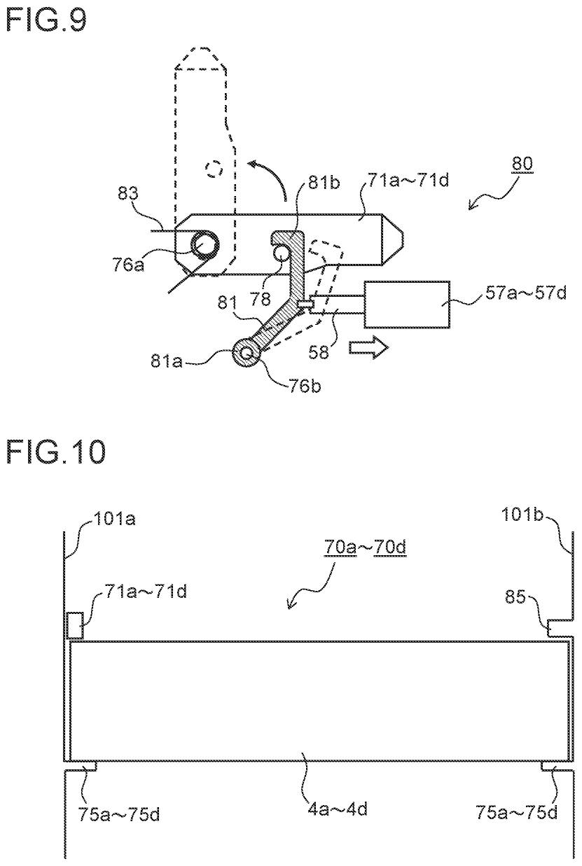

The solenoids 57a to 57d constitute a lock release driving portion 80 (see FIG. 9), and drive (make swing) locking members 71a to 71d (see FIG. 6), which are provided in a container mount portion 70, individually to release the toner containers 4a to 4d from a locked state.

The operation portion 60 includes the liquid crystal display portion 61 and LEDs 62 that indicate various states. The user operates a stop/clear button on the operation portion 60 to stop image formation, and operates a reset button to turn the various settings of the image forming apparatus 100 back to the default settings. The liquid crystal display portion 61 displays the state of the image forming apparatus 100, the status of image formation, the number of sheets printed, and remaining toner information such as “near-depletion” and “toner depletion”. Various settings on the image forming apparatus 100 are made from a printer driver on the personal computer.

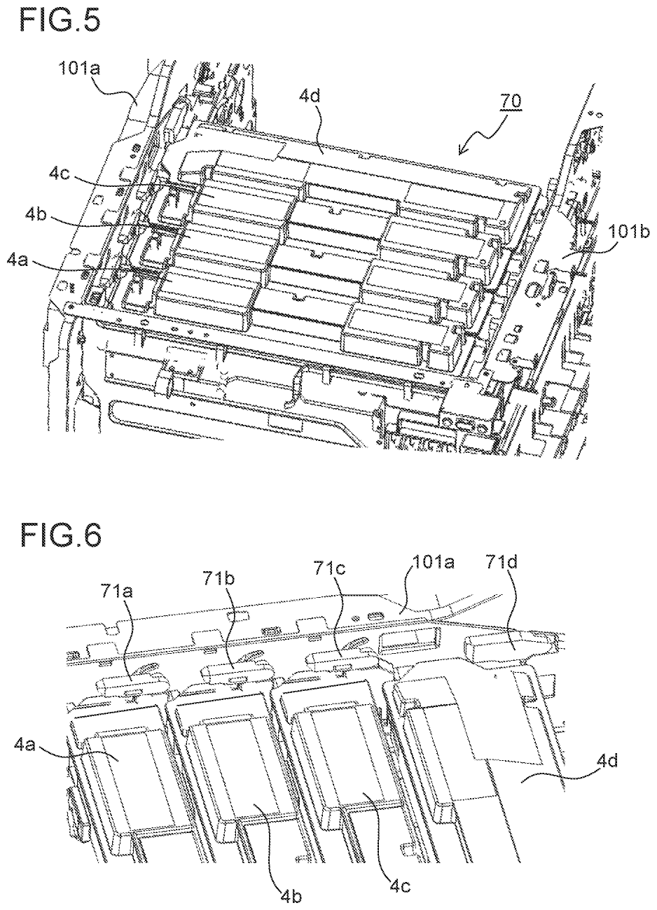

FIG. 5 is a perspective view of the image forming apparatus 100 with the top cover 17a open, as seen from above. FIG. 6 is an enlarged part view around the locking members 71a to 71d for the toner containers 4a to 4d in FIG. 5 (around a left end part in FIG. 5). As shown in FIG. 5, inside the top cover 17a (see FIG. 1), a container mount portion 70 is provided.

The container mount portion 70 supports the toner containers 4a to 4d at their opposite ends as if bridging between a rear frame 101a and a front frame 101b of the image forming apparatus 100, and permits the toner containers 4a to 4d to be mounted and dismounted from above. The container mount portion 70 includes locking members 71a to 71d that lock one end parts (in FIG. 5, left end parts) of the toner containers 4a to 4d in their longitudinal direction.

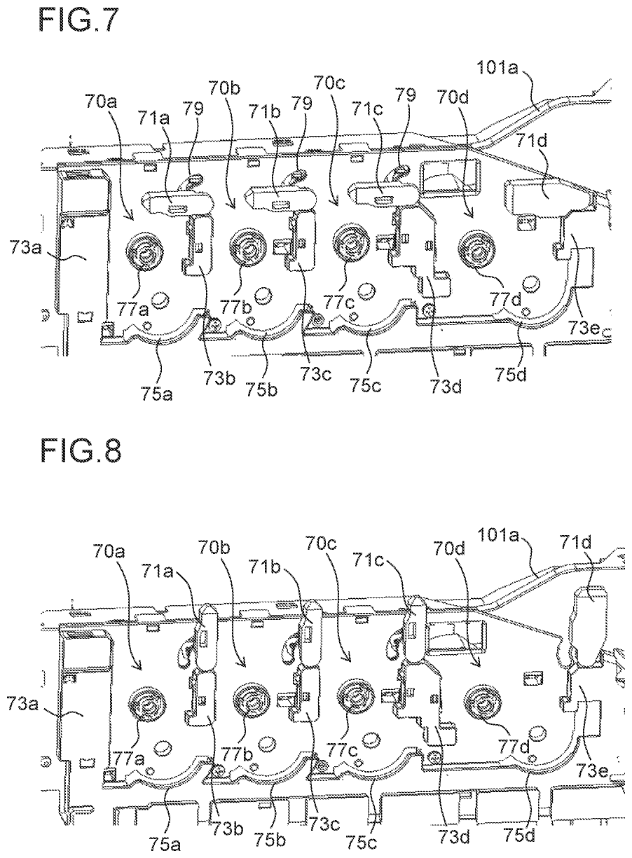

FIGS. 7 and 8 are perspective views showing a structure of the container mount portion 70 at its rear frame 101a side, respectively showing a locked state and an unlocked state achieved by the locking members 71a to 71d.

As shown in FIG. 7, on the rear frame 101a, there are provided side support rails 73a to 73e which support the side faces of the toner containers 4a to 4d and bottom support portions 75a to 75d which support the bottom faces of the toner containers 4a to 4d. The part surrounded by a pair of side support rails 73a and 73b and a bottom support portion 75a serves as a first mount portion 70a in which the toner container 4a is mounted.

Likewise, the part surrounded by a pair of side support rails 73b and 73c and a bottom support portion 75b, the part surrounded by a pair of side support rails 73c and 73d and a bottom support portion 75c, and the part surrounded by a pair of side support rails 73d and 73e and a bottom support portion 75d respectively serve as a second to a fourth mount portion 70b to 70d in which the toner containers 4b to 4d are mounted.

In middle parts of the first to fourth mount portions 70a to 70d, there are arranged drive-side couplings 77a to 77d which feed the rotation driving force of the toner supply motor 27 (see FIGS. 3 and 4) to the conveying screw 43 (see FIG. 3) in the toner containers 4a to 4d. The locking members 71a to 71d are arranged adjacent to top end parts of the side support rails 73b to 73e respectively.

Though not illustrated, at opposite positions on the front frame 101b, there are arranged a first to a fourth mount portion 70a to 70d which include side support rails 73a to 73e and bottom support portions 75a to 75d. On the first to fourth mount portions 70a to 70d on the front frame 101b, stoppers 85 (see FIG. 10) are provided instead of locking members 71a to 71d.

The locking members 71a to 71d are swingable between a position (first position) in which they are perpendicular to the extension direction (the up-down direction) of the side support rails 73a to 73e indicated in FIG. 7 and a position (second position) in which they are parallel to the extension direction (the up-down direction) of the side support rails 73a to 73e indicated in FIG. 8. The locking members 71a to 71d swing between the first and second positions along the rear frame 101a. This keeps the locking members 71a to 71d supported on the rear frame 101a over their entire swing range, and allows stable swinging of the locking members 71a to 71d.

The locking members 71a to 71d being in the first position constitutes a locked state where dismounting of the toner containers 4a to 4d is restrained. The locking members 71a to 71d being in the second position constitutes an unlocked state where dismounting of the toner containers 4a to 4d is allowed. The locking members 71a to 71d are each swung between the first and second positions individually by a lock release driving portion 80 (see FIG. 9).

FIG. 9 is a diagram showing the lock release driving portion 80 of the locking members 71a to 71d as seen from the rear side in FIG. 7. The structure of the lock release driving portion 80 is the same for the locking members 71a to 71d, and accordingly it will here be described with reference to a single diagram. The lock release driving portion 80 includes a solenoid 57a to 57d, a link member 81, and a torsion spring 83.

The locking member 71a to 71d is supported swingably about a first pivot 76a as a swinging pivot formed on the rear frame 101a. The first pivot 76a is fitted with the torsion spring 83 so as to bias the locking member 71a to 71d toward the second position (counter-clockwise in FIG. 9). On the side face of the locking member 71a to 71d, an engagement projection 78 is provided. The engagement projection 78 is provided at a position away from the first pivot 76a toward a tip end part, and engages with an arc-form guide hole 79 (see FIG. 7) formed in the rear frame 101a. This restricts the swinging range of the locking member 71a to 71d between the first and second positions.

A link member 81 has a bearing portion 81a and a hook portion 81b. The bearing portion 81a rotatably engages with a second pivot 76b formed on the rear frame 101a. The hook portion 81b is formed at the swinging end of the link member 81, and engages with the engagement projection 78 on the locking member 71a to 71d. To a bent part between the bearing portion 81a and the hook portion 81b, a plunger 58 of the solenoid 57a to 57d is coupled.

With the toner containers 4a to 4d mounted in the first to fourth mount portions 70a to 70d, the hook portion 81b of the link member 81 is engaged with the engagement projection 78 on the locking member 71a to 71d, and the locking member 71a to 71d is held in the first position (indicated by solid lines in FIG. 9) against the biasing force of the torsion spring 83.

When the solenoid 57a to 57d is energized, the plunger 58 is pulled into the solenoid 57a to 57d, and the link member 81, which is coupled to the plunger 58, swings clockwise. This results in the hook portion 81b being disengaged from the engagement projection 78, and thus the locking member 71a to 71d moves to the second position (indicated by broken lines in FIG. 9) under the biasing force of the torsion spring 83.

When the solenoid 57a to 57d is deenergized, the plunger 58 is pushed out of the solenoid 57a to 57d; thus the link member 81 swings counter-clockwise and moves back to the position where it can engage with the engagement projection 78. In this state, pressing the locking member 71a to 71d downward against the biasing force of the torsion spring 83 causes the engagement projection 78 to engage with the hook portion 81b, and thus the locking member 71a to 71d is kept in the first position.

FIG. 10 is a side view schematically showing a state where the toner containers 4a to 4d are amounted in the first to fourth mount portions 70a to 70d in the container mount portion 70. How the toner containers 4a to 4d are mounted is the same for the first to fourth mount portions 70a to 70d, and accordingly it will here be described with reference to a single diagram.

As shown in FIG. 10, one end portion (right end portion in FIG. 10) of the toner container 4a to 4d is held between the bottom support portion 75a to 75d and the stopper 85 on the front frame 101b. An other end portion (left end portion in FIG. 10) of the toner container 4a to 4d is held between the bottom support portion 75a to 75d and the locking member 71a to 71d on the rear frame 101a. Thus, dismounting of the toner container 4a to 4d is restrained.

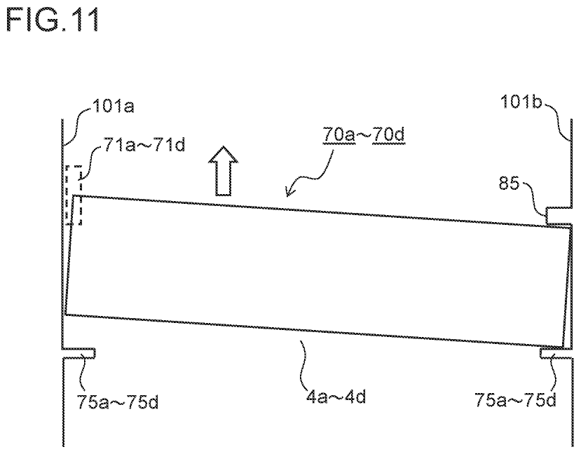

An empty toner container 4a to 4d is replaced in the following manner. The solenoid 57a to 57d is energized so that the locking member 71a to 71d swings from the first position to the second position. Now, dismounting of the toner container 4a to 4d is allowed. A serviceperson lifts up the rear frame 101a side (left side in FIG. 11) of the toner container 4a to 4d to take it out from between the bottom support portion 75a to 75d and the stopper 85. In this way, the toner containers 4a to 4d can be taken out of the first to fourth mount portions 70a to 70d.

A new toner container 4a to 4d is mounted in the following manner. First, the front frame 101b side of the toner container 4a to 4d is inserted between the bottom support portion 75a to 75d and the stopper 85. Then, the rear frame 101a side of the toner container 4a to 4d is mounted in the first to fourth mount portion 70a to 70d along the locking members 71a to 71d and the side support rail 73b to 73ezon. Lastly, the locking member 71a to 71d is manually swung from the second position to the first position, and this completes the replacement of the toner container 4a to 4d.

As shown in FIG. 8, when the locking members 71a to 71d are in the second position, they stand upright on the extension lines of the side support rails 73a to 73e. This permits the toner containers 4a to 4d, when mounted in and dismounted from the first to fourth mount portions 70a to 70d, to be taken out and inserted smoothly along the side support rails 73a to 73e and the locking members 71a to 71d. Thus, the locking members 71a to 71d function as parts of rail members during mounting and dismounting of the toner containers 4a to 4d in and from the first to fourth mount portions 70a to 70d.

Moreover, when the locking members 71a to 71d are in the second position, as shown in FIG. 8, their tip end portions protrude upward out of the rear frame 101a, and this prevents the top cover 17a from being closed completely. This eliminates the likelihood of, after mounting the toner containers 4a to 4d, the user forgetting to operate the locking members 71a to 71d to move them back to the first position. With a configuration where, when the top cover 17a is pressed with hands to be completely closed, the locking members 71a to 71d swing to the first position, it is possible to omit the need to operate the locking members 71a to 71d individually to swing them to the first position.

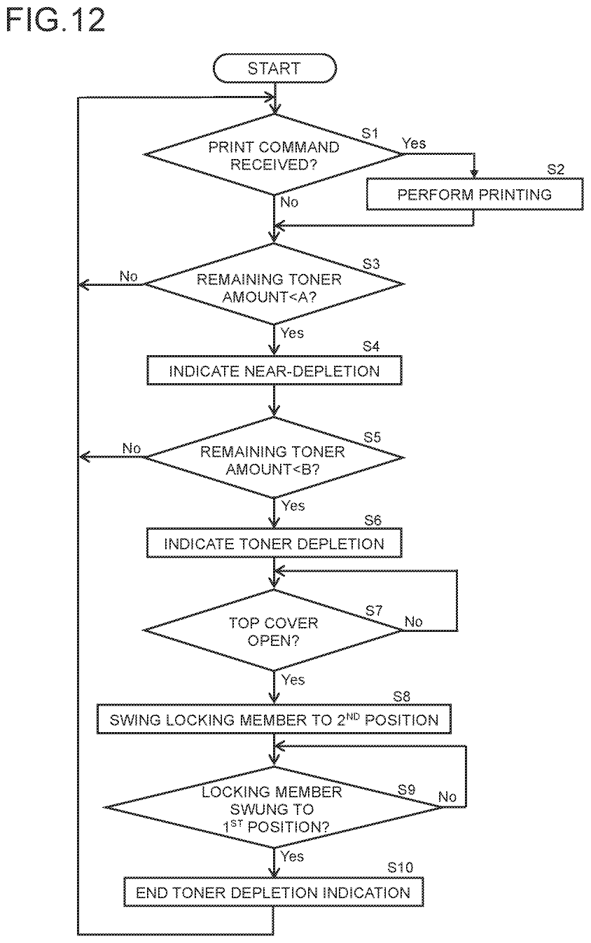

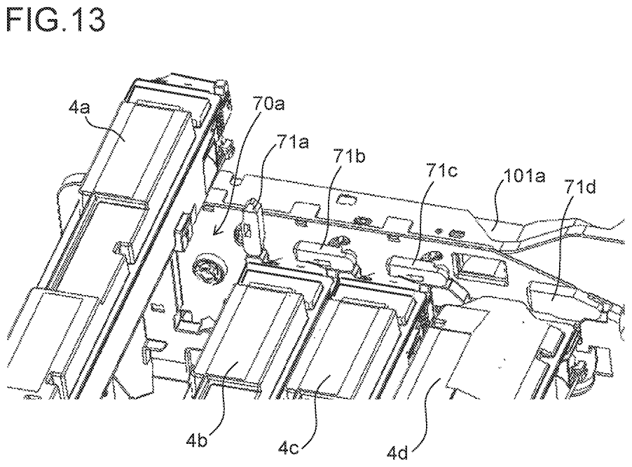

FIG. 12 is a flow chart showing a procedure for replacing the toner containers 4a to 4d in the image forming apparatus 100 according to the embodiment. The procedure for replacing the toner containers 4a to 4d will now be described along the steps in FIG. 12 with reference also to FIGS. 1 to 11 as well as FIG. 13, which will be described later.

First, the control portion 90 checks whether a print command is received (Step S1). If a print command is received (Step S1, Yes), printing is performed through ordinary image forming operation (Step S2). If no print command is received (Step S1, No), the control portion 90 checks whether the remaining toner amount in the toner containers 4a to 4d as sensed by the remaining toner amount sensing portion 56 is less than a threshold value A (Step S3).

If the remaining toner amount is equal to or more than A (Step S3, No), a return is made to Step S1, where a transition is made to a standby state waiting for a print command. If the remaining toner amount in any of the toner containers 4a to 4d is less than A (Step S3, Yes), that one of the toner containers 4a to 4d is estimated to be close to empty; thus, on the liquid crystal display portion 61, a message alerting the user to “near-depletion” in the toner container 4a to 4d in question is displayed (Step S4).

Next, the control portion 90 checks whether the remaining toner amount in the toner containers 4a to 4d as sensed by the remaining toner amount sensing portion 56 is less than a threshold value B (B<A) (Step S5). If the remaining toner amount is equal to or more than B (Step S5, No), a return is made to Step S1, where a transition is made to the standby state waiting for a print command. If the remaining toner amount in any of the toner containers 4a to 4d is less than B (Step S5, Yes), that one of the toner containers 4a to 4d is estimated to be empty; thus, the control portion 90 displays, on the liquid crystal display portion 61, a message alerting the user to “toner depletion” in the toner container 4a to 4d in question (Step S6).

Next, the control portion 90 checks, based on a sense signal from the open-close sensing switch 63, whether the top cover 17a is opened (Step S7). If the top cover 17a is opened (Step S7, Yes), a control signal is transmitted to one of the solenoids 57a to 57d, thereby to make the locking member 71a to 71d of the toner container 4a to 4d corresponding to that one of the toner containers 4a to 4d which has been found to be empty swing from the first position to the second position (Step S8).

For example, when the remaining toner amount in the toner container 4a is less than B, only the locking member 71a is swung to the second position. As a result, as shown in FIG. 13, the toner container 4a can now be mounted in or dismounted from the first mount portion 70a. On the other hand, the lock members 71b to 71d are kept in the first position, and thus dismounting of the toner containers 4b to 4d is restrained.

Next, the control portion 90 checks whether the locking member 71a to 71d, which was swung to the second position in Step S8, has swung to the first position (Step S9). If it has not swung to the first position (Step S9, No), the corresponding toner container 4a to 4d is estimated either not to have been replaced yet or to have been replaced but left unlocked by the locking member 71a to 71d. Accordingly, on the liquid crystal display portion 61, toner depletion continues to be indicated.

If the locking member 71a to 71d has been swung to the first position (Step S9, Yes), the corresponding toner container 4a to 4d has been replaced and locked, thus toner depletion ceases to be indicated (Step S10). Then a return is made to Step S1, where a transition is made to the standby state waiting for a print command.

With a configuration according to the present disclosure, when the locking member 71a to 71d is in the second position, it stands upright on the extension line of the side support rail 73b to 73e. That is, the locking member 71a to 71d and the corresponding side support rail 73b to 73e are arranged in a straight line. Thus, the locking member 71a to 71d together with the side support rail 73b to 73e functions as a rail member during mounting and dismounting of the toner container 4a to 4d, and this allows smooth replacement of the toner container 4a to 4d.

The locking member 71a to 71d overlaps only a rear frame 101a side part of the toner container 4a to 4d. This helps make the locking member 71a to 71d more compact than ever, and is particularly advantageous in a construction where the toner container 4a to 4d is mounted and dismounted from above the container mount portion 70.

When the locking member 71a to 71d is in the second position, the tip end of the locking member 71a to 71d protrudes upward out of the rear frame 101a and the front frame 101b, and prevents the top cover 17a (see FIG. 1) from being closed. This prevents the user from forgetting to lock the toner container 4a to 4d

With the procedure for replacement shown in FIG. 12, only the locking member 71a to 71d corresponding to whichever of the toner containers 4a to 4d needs to be replaced swings to the second position to release the locked state. This prevents a toner container 4a to 4d that does not need to be replaced from being replaced by mistake.

It is only after the top cover 17a is confirmed to be open that the locking member 71a to 71d is swung from the first position to the second position. This helps prevent the locking member 71a to 71d from colliding with the top cover 17a. It is thus possible to prevent collision noise and destruction of the locking member 71a to 71d or the lock release driving portion 80.

The present disclosure is not limited by the embodiments described above and allows for many modifications without departing from the spirit of the present disclosure. For example, the materials, shapes, arrangements, and the like of components specifically described above are merely illustrative and are not meant to limit the scope of the present disclosure to them unless particularly specified.

For example, in the embodiment described above, when, despite toner being supplied, the toner concentration in the developer holder 20 as sensed by the toner concentration sensor 23 does not rise, the toner container 4a to 4d is judged to be empty of toner (toner depletion). Instead, there may be provided a remaining toner amount sensor that directly senses the remaining toner amount in the toner container 4a to 4d.

In the embodiment described above, the locking members 71a to 71d are provided adjacent to, respectively, one of the pair of side support rails 73a and 73b provided in the first mount portion 70a, one of the pair of side support rails 73b and 73c provided in the second mount portion 70b, one of the pair of side support rails 73c and 73d provided in the third mount portion 70c, and one of the pair of side support rails 73d and 73e provided in the fourth mount portion 70d. Instead, for example, the locking members 71a may be provided adjacent to each of the pair side support rails 73a and 73b provided in the first mount portion 70a.

Needless to say, the present disclosure is applicable not only to color printers like the one shown in FIG. 1 but to various image forming apparatuses including a replaceable toner holder, such as monochrome printers, monochrome multifunction peripherals, rotary or tandem color copiers and facsimile machines.

The present disclosure finds applications in image forming apparatuses that incorporate a toner holder which is dismountably mounted in the body of the image forming apparatus. Based on the present disclosure, it is possible to provide an image forming apparatus that allows mounting and dismounting of only a toner holder that needs to be replaced and that allows easy mounting and dismounting of a toner holder.

What is claimed is:

1. An image forming apparatus, comprising:
an image carrying member on which an electrostatic latent image is formed;
a developing device that forms a toner image by attaching toner to the electrostatic latent image formed on the image carrying member;
a toner holder that is dismountably mounted and that stores the toner to be supplied to the developing device;
a toner holder mount portion in which the toner holder is mounted; and
a locking member that restrains mounting and dismounting of the toner holder in and from the toner holder mount portion,
wherein
the toner holder mount portion has a pair of side support rails that supports a side face of the toner holder,
the locking member is arranged adjacent to an upstream end part, in a mounting direction of the toner holder, of at least one of the pair of side support rails, the locking member being swingable between a first position where the locking member is perpendicular to an extension direction of the side support rails and restrains mounting and dismounting of the toner holder and a second position where the locking member is parallel to the extension direction of the side support rails and allows mounting and dismounting of the toner holder, and
the locking member, when in the second position, is arranged on an extension line of the side support rails and guides, together with the side support rails, the toner holder to and from the toner holder mount portion.

2. The image forming apparatus according to claim 1, wherein
the toner holder mount portion is formed between a pair of frames arranged opposite each other, and
the pair of side support rails is supported by the pair of frames respectively, and
the locking member swings between the first and second positions along at least one of the pair of frames.

3. The image forming apparatus according to claim 2, wherein
the toner holder can be mounted in and dismounted from the toner holder mount portion from above,
the side support rails are supported substantially vertical along the pair of frames, and
the locking member is arranged adjacent to a top end part of one of the pair of side support rails.

4. The image forming apparatus according to claim 3, further comprising:
a top cover that covers over the toner holder mount portion and that can be opened and closed,
wherein
the locking member, when in the second position, protrudes upward beyond a closed position of the top cover.

5. The image forming apparatus according to claim 4, wherein
the locking member swings from the second position to the first position as the top cover is closed.

6. The image forming apparatus according to claim 4, further comprising:
an open-close sensing switch that senses whether the top cover is open or closed;
a lock release driving portion that releases a restrained state by the locking member; and
a control portion that controls the lock release driving portion,
wherein
when the open-close sensing switch senses the top cover being opened, the control portion controls such that the lock release driving portion makes the locking member swing to the second position.

7. The image forming apparatus according to claim 1, further comprising:
a remaining toner amount sensing portion that can detect a toner depletion state where a remaining toner amount in the toner holder is equal to or less than a predetermined amount;
a lock release driving portion that releases a restrained state by the locking member; and
a control portion that controls the lock release driving portion,
wherein
when the remaining toner amount sensing portion detects the toner depletion state, the control portion controls such that the lock release driving portion makes the locking member swing to the second position.

8. The image forming apparatus according to claim 7, further comprising:
a plurality of the developing devices that form the toner images of different colors on a plurality of the image carrying members; and
a plurality of the toner holders that store the toner of different colors to be supplied to the plurality of the developing devices,
wherein
when the remaining toner amount sensing portion detects the toner depletion state in any of the toner holders, the control portion makes only the locking member that restrains mounting and dismounting of the toner holder in which the toner depletion state has been detected swing to the second position.

9. The image forming apparatus according to claim 7, further comprising:
a display portion that indicates the toner depletion state detected by the remaining toner amount sensing portion,
wherein
when the locking member swings from the second position to the first position, the control portion ends indication of the toner depletion state by the display portion.

10. The image forming apparatus according to claim 7, wherein
the lock release driving portion includes:
a biasing member that biases the locking member toward the second position;
a link member swingable and having a hook portion that engages with an engagement projection on the locking member, wherein, with the hook portion engaged with the engagement projection, the link member keeps the locking member in the first position; and
a solenoid having a plunger coupled to the link member, wherein, as the plunger is pulled in, the solenoid disengages the hook portion from the engagement projection.
